(19) United States
(12) Patent Application Publication
(10) Pub. No.: US 2019/0299038 A1
(43) Pub. Date: Oct. 3, 2019

(54) Mobile Sprinkler System

(71) Applicant: Raul Hernandez, Santa Barbara, CA (US)

(72) Inventor: Raul Hernandez, Santa Barbara, CA (US)

(21) Appl. No.: 16/359,492

(22) Filed: Mar. 20, 2019

Related U.S. Application Data
(60) Provisional application No. 62/761,654, filed on Apr. 2, 2018.

(51) Int. Cl. A62C 3/02; B05B 9/00; B05B 9/04

(52) U.S. Cl. CPC A62C 3/0292; B05B 9/0403; B05B 9/007

(57) ABSTRACT

A mobile sprinkler system has a container made from a fire-resistant polymer material for holding liquid, a support frame under the container supporting the container above ground level, a pump coupled to draw liquid from the container, an outflow conduit coupled to the pump and directed above the container to conduct liquid provided by the pump to a spray head at an upper extremity of the outflow conduit, a power supply adapted to power the pump and any electrical elements other than the pump, and a mechanical lifting interface mounted on the container and adapted to interact with a lifting and carrying vehicle. The container is filled with fire-retardant liquid and the mobile sprinkler system is deployed to an area where fire may be expected and is activated to spray the fire-retardant liquid at the spray head to prevent or control a fire.

### CROSS-REFERENCE TO RELATED APPLICATIONS

The present application claims priority to Provisional Patent Application 62/761,654 filed Apr. 4, 2018, and all disclosure of the parent application is incorporated herein at least by reference.

### BACKGROUND OF THE INVENTION

### 1. Field of the Invention

The present invention is in the technical area of firefighting equipment and pertains more particularly to a mobile sprinkler system useful in protecting against wildfires.

### 2. Description of Related Art

At the time of the present application, throughout the nation, the U.S. Department of Interior states that people cause 90 percent of wildfires. From Jan. 1 to Dec. 22, 2017, there were 66,131 wildfires, compared to 65,575 wildfires in the same period in 2016, according to the National Interagency Fire Center. About 9.8 million acres were burned in the 2017 period, compared with 5.4 million in 2016. As of December 22, for the year so far, 2017 ranked higher in the number of acres burned compared to the 10-year average, according to the Fire Center.

Putting out unexpected and spreading hotspots started by fire cinders and debris makes firefighting a very difficult job and most importantly, increases the danger to lives and property. In many large fires today, when a fire breaks out, homeowners sometimes stay behind and use garden hoses to wet rooftops and to try to protect property. This puts home and property owners in danger when performing this hazardous task because they often climb ladders to hose down and wet their houses' roofs or other property.

There is clearly a compelling need to find solutions to fight fires. Recent fires just in California, for example, can illustrate the loss of life and the destruction. Beginning October 6 and continuing until Oct. 25, 2018, eight counties in Northern California were hit by a devastating outbreak of wildfires, which led to at least 23 fatalities, burned 245,000 acres and destroyed over 8,700 structures, according to the Fire Center.

In December 2017, five major fires in Southern California destroyed over a thousand homes and buildings. One of the fires, the Thomas Fire in Ventura and Santa Barbara counties, became the largest wildfire ever recorded in California. Catastrophe modeling firm RMS estimates that the Thomas Fire will cost up to $2.5 billion in insured losses. Further, the California Department of Insurance reported that insurance claims from the October-December 2017 fires add up to almost $12 billion.

Although firefighting equipment and methods are well-known, there is a clear need for new and better ways to prevent and to fight wildfires.

### BRIEF SUMMARY OF THE INVENTION

In one embodiment of the invention a mobile sprinkler system is provided, comprising a container made from a fire-resistant polymer material for holding liquid, a support frame under the container supporting the container above ground level, a pump coupled to draw liquid from the container, an outflow conduit coupled to the pump and directed above the container to conduct liquid provided by the pump to a spray head at an upper extremity of the outflow conduit, a power supply adapted to power the pump and any electrical elements other than the pump, and a mechanical lifting interface mounted on the container and adapted to interact with a lifting and carrying vehicle. The container is filled with fire-retardant liquid and the mobile sprinkler system is deployed to an area where fire may be expected and is activated to spray the fire-retardant liquid at the spray head to prevent or control a fire.

In one embodiment the power supply comprises a rechargeable storage battery with a charging port. Also, in one embodiment the storage battery is located under the container on the support frame. In one embodiment the system further comprises a solar panel system coupled to circuitry to recharge the battery. And in one embodiment the power supply comprises an electrical generator driven by an internal combustion engine.

In one embodiment the sprinkler system further comprises an electrically powered starter system adapted to turn and start the internal combustion engine to drive the generator. Also, in one embodiment the system further comprises actuators, sensors and control circuitry adapted to start and stop the pump. Also, in one embodiment the control circuitry further comprises wireless communication circuitry and actuators adapted to start and stop the pump remotely. In one embodiment the system further comprises control circuitry adapted to be remotely controlled to start the internal-combustion engine. And in one embodiment the spray head has electrical actuators controllable to adjust spray direction and spray characteristics, and the control circuitry is adapted to control the spray head from remote commands.

In another aspect of the invention a method for managing local conditions relative to fire potential is provided, comprising filling a container made from a fire-resistant polymer material for holding liquid, the container supported on a support frame above ground level, the container having a pump coupled to draw liquid from the container, with a fire-retardant liquid, transporting the filled container to a place where it is desired to prevent fire in vegetation around the container, starting a pump coupled to draw liquid from the container, pumping the fire-retardant liquid through an outflow conduit coupled to the pump and directed above the container, to a spray head at an upper extremity of the outflow conduit, spraying the fire-retardant liquid away from the container.

In one embodiment the method comprises powering the pump with a rechargeable storage battery having a charging port. Also, in one embodiment the method comprises locating the storage under the container on the support frame. Also, in one embodiment, the method comprises recharging the storage battery with a solar panel system mounted on the container. And in one embodiment the method comprises charging the battery with an electrical generator driven by an internal combustion engine.

In one embodiment the method comprises turning and starting the internal combustion engine by an electrically powered starter system. Also, in one embodiment, the method comprises starting and stopping the pump through actuators, sensors and control circuitry adapted for the purpose. Also, in one embodiment the method comprises starting and stopping the pump remotely through wireless communication circuitry and actuators adapted for the purpose. In one embodiment the method comprises starting the internal combustion engine remotely by wireless communication with control circuitry. And in one embodiment the method comprises controlling the spray head in direction and spray characteristics by remote commands sent wirelessly to control circuitry to manipulate the spray head through electrical actuators.

### BRIEF DESCRIPTION OF THE SEVERAL VIEWS OF THE DRAWINGS

FIG. 1 is a perspective view of a mobile firefighting system in an embodiment of the present invention

### DETAILED DESCRIPTION OF THE INVENTION

In one embodiment of the invention a mobile unit is provided that comprises container of a size to hold at least several hundred gallons of water, a fire retardant, or a mixture. This mobile unit in different embodiments comprises at minimum a powerful pump connected to typically a vertically oriented pipe ending in spray apparatus, and a power supply to power the pump when needed. The unit further has a ground interface to keep the container off of ground, and a carrier interface enabling the container to be manipulated, such as to be carried and placed by a helicopter or ground vehicles.

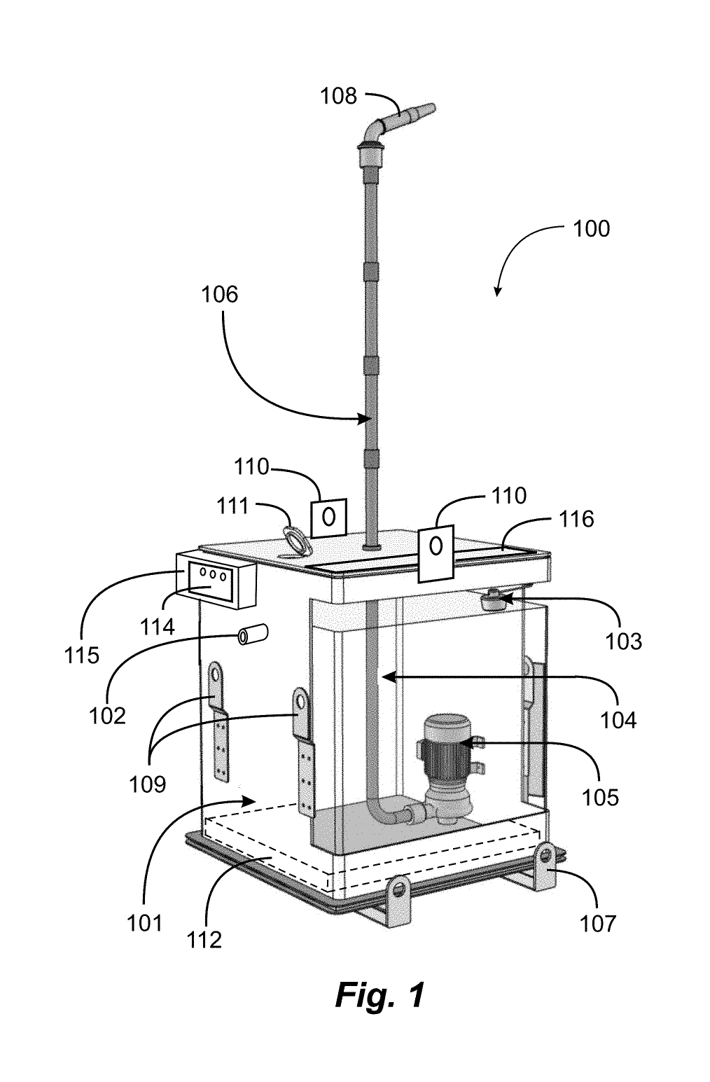

FIG. 1 is a perspective view of a mobile firefighting system 100 in one embodiment of the invention. In this system container 101 made in one embodiment of a fire retardant and fire-resistant plastic material is capable of holding a substantial volume of water or other liquid for fighting fires. In different embodiments the volume capability may be from perhaps 100 gallons to much larger systems capable of several h8ndred gallons of liquid.

Container 101 in one embodiment rests on metal stands 107 to protect the container from objects on ground level. The metal stands may be adapted for stakes to be driven into ground to steady the containers. The system also has in one embodiment attachment elements, such as elements 109 for use by ground units to pick up and move containers, and elements 110 adapted to enable pick-up and delivery by helicopters, or by other manned or unmanned aerial vehicles.

In embodiments of the system there may be one or more filling ports 111 with removable sealing caps. In some embodiments there is a powerful submersible pump 105 coupled to a conduit 104 extending in sections 106 ending in a spray nozzle 108. In some embodiments the pump may be external to the container. The pump, and in some cases valves and some other electrical or electronic elements are powered by a battery 112 that may be built into a base of the system below the container. This battery has a charging port, and the battery may be pre charged and the container filled prior to deployment of a system in an area to help prevent or contain a fire. In some embodiments a generator driven by an internal combustion engine may be employed to power the pump and other elements, and in some cases the engine driving the generator may be started by a starter system remotely commanded through a wireless system. Also, in some embodiments there may be solar panels 116 for recharging battery 112, or a smaller battery that may be used to power a control system, wireless communication and a starter for an engine for e generator to power pump 105.

In embodiments of the invention mobile containers according to embodiments of the invention may be deployed, for example, in a line in a path of an advancing wild fire and may be operated to create a wet buffer to stop the advancing fire. Deployment may also be in a pattern to create a wet area of pre-determined size to keep embers and cinders from spreading a fire.

In some embodiments, units may be deployed with the upwardly extending conduit 106 removed and packed alongside the unit in sections, and firefighters in the field may be responsible for setting up and starting operation of individual units. The hole through which the upwardly-extending conduit exits may be temporarily plugged by a cap for the purpose. The upwardly extending conduit may be implemented from a very short dimension up to as much as ten feet or more. In this circumstance a control panel 114 may be used, connected to a system of control circuitry 115.

The uppermost conduit in the upward-extending conduit may be attached to a sprinkler 108 that may be adjusted to spray in a variety of ways. In one embodiment sprinkler 108 has electrical actuators connected to control system 115, enabling the spray direction and characteristics to be adjusted. The sprinklers may also, in some embodiments be caused to rotate through a portion of a full circle, or in a full circle. Stream pattern may also be adjusted. In some cases, the spray direction may be directly upward to send a fine mist high into the air where it can spread throughout an area by winds. This can create a thick or thin wall of mist, depending on the jet flow. A fine vertical spray wall may make it difficult for fire cinders or smoldering debris to be carried by winds to dry places and ignite a dry spot or area.

A solar panel 116 may be employed for recharging a battery, or for powering electrical elements, or both. In some cases, control circuitry 115 may comprise wireless communication circuitry, and various functions of the container unit may be controlled remotely, or by execution of software or firmware on a processor in the control circuitry. There may also be facility in circuitry 115 to measure wind velocity and direction, gauge the amount of water in the container, and to adjust the flow and direction of the water being sprayed. This data may be sent to a remote hub for firefighters or experts to analyze.

A fill line 102 is provided in some embodiments to allow an ordinary garden hose to be connected to fill the container. The hose may also be used be used to draw water from different sources including a water faucet, pool, well, pond or stream. Fill line 102 may also be connected to large-fill reservoirs brought in by air or land and put next or near the deployed container systems. A standard float 103 inside the container may be used to regulate the water flow into and out of the container.

Systems according to embodiments of the invention may be used by homeowners or business owners to set up near a house or building with the upward conduit set up to spray a rooftop. A ring of systems may be used to create a no-fire zone around a house or other building. Such a system may be set up and may have sensors and triggers to activate even when a home or business owner is not on the premises.

The person skilled in the art will understand that the embodiments described above are exemplary only, and that are wide variety of alterations may be made within the scope of the invention. The scope is limited only by the claims below.

I claim:

1. A mobile sprinkler system, comprising:
a container made from a fire-resistant polymer material for holding liquid;
a support frame under the container supporting the container above ground level;
a pump coupled to draw liquid from the container;
an outflow conduit coupled to the pump and directed above the container to conduct liquid provided by the pump to a spray head at an upper extremity of the outflow conduit;
a power supply adapted to power the pump and any electrical elements other than the pump; and
a mechanical lifting interface mounted on the container and adapted to interact with a lifting and carrying vehicle;
wherein the container is filled with fire-retardant liquid and the mobile sprinkler system is deployed to an area where fire may be expected and is activated to spray the fire-retardant liquid at the spray head to prevent or control a fire.

2. The mobile sprinkler system of claim 1 wherein the power supply comprises a rechargeable storage battery with a charging port.

3. The mobile sprinkler system of claim 2 wherein the storage battery is located under the container on the support frame.

4. The mobile sprinkler system of claim 2 further comprising a solar panel system coupled to circuitry to recharge the battery.

5. The mobile sprinkler system of claim 1 wherein the power supply comprises an electrical generator driven by an internal combustion engine.

6. The mobile sprinkler system of claim 5 further comprising an electrically powered starter system adapted to turn and start the internal combustion engine to drive the generator.

7. The mobile sprinkler system of claim 1 further comprising actuators, sensors and control circuitry adapted to start and stop the pump.

8. The mobile sprinkler system of claim 7 wherein the control circuitry further comprises wireless communication circuitry and actuators adapted to start and stop the pump remotely.

9. The mobile sprinkler system of claim 6 further comprising control circuitry adapted to be remotely controlled to start the internal-combustion engine.

10. The mobile sprinkler system of claim 7 wherein the spray head has electrical actuators controllable to adjust spray direction and spray characteristics, and the control circuitry is adapted to control the spray head from remote commands.

11. A method for managing local conditions relative to fire potential, comprising:
filling a container made from a fire-resistant polymer material for holding liquid, the container supported on a support frame above ground level, the container having a pump coupled to draw liquid from the container, with a fire-retardant liquid;
transporting the filled container to a place where it is desired to prevent fire in vegetation around the container; and
starting a pump coupled to draw liquid from the container, pumping the fire-retardant liquid through an outflow conduit coupled to the pump and directed above the container, to a spray head at an upper extremity of the outflow conduit, spraying the fire-retardant liquid away from the container.

12. The method of claim 11 comprising powering the pump with a rechargeable storage battery having a charging port.

13. The method of claim 12 comprising locating the storage under the container on the support frame.

14. The method of claim 12 further comprising recharging the storage battery with a solar panel system mounted on the container.

15. The method of claim 11 comprising charging the battery with an electrical generator driven by an internal combustion engine.

16. The method of claim 15 further comprising turning and starting the internal combustion engine by an electrically powered starter system.

17. The method of claim 11 further comprising starting and stopping the pump through actuators, sensors and control circuitry adapted for the purpose.

18. The method of claim 17 further comprising starting and stopping the pump remotely through wireless communication circuitry and actuators adapted for the purpose.

19. The method of claim 16 further comprising starting the internal combustion engine remotely by wireless communication with control circuitry.

20. The method of claim 17 comprising controlling the spray head in direction and spray characteristics by remote commands sent wirelessly to control circuitry to manipulate the spray head through electri9cal actuators.
